(19) United States
(12) Patent Application Publication
(10) Pub. No.: US 2008/0013139 A1
(43) Pub. Date: Jan. 17, 2008

(54) Method of displaying object image

(75) Inventors: Shuji Maruyama, Inzai-city (JP); Tomoyuki Hirota, Inzai-city (JP)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR); Hyundai Motor Japan R&D Center, Inc., Chiba (JP)

(21) Appl. No.: 11/637,303

(22) Filed: Dec. 11, 2006

(30) Foreign Application Priority Data
Jul. 13, 2006 (KR) 10-2006-0065803

(51) Int. Cl. G03H 1/26

(52) U.S. Cl. 359/23

(57) ABSTRACT

The present invention relates to a method of displaying an object, in which the object is formed by displaying a two-dimensional object image on a plurality of displaying surfaces which are respectively disposed at different positions having different depths from each other. The luminance of the two-dimensional image displayed on each displaying surface is changed independently such that when the object image is moved farther in depth, the luminance of the object image displayed on a surface nearer to the observer is reduced and the luminance of the object image displayed on a surface farther from the observer is increased.

### CROSS-REFERENCE TO RELATED APPLICATIONS

This application claims priority from Korean Patent Application No. 2006-000036, filed on Jul. 13, 2006 with the Korean Intellectual Property Office, the disclosure of which is incorporated herein by reference.

### BACKGROUND OF INVENTION

1. Field of Invention

The present invention relates to a method of displaying an object image formed by displaying a two-dimensional image on a plurality of displaying surfaces at different positions and having different depths from each other More particularly, to a method of displaying an object image comprising of multiple images displayed at various depths such that when the object image is rotated, the multiple images appear to be congruent from the standpoint of the observer

2. Background

Generally, the development of a three-dimensional image displaying device is important in various fields such as home electronic industry, communication industry, aerospace industry, artistic industry, automotive industry. Considering the myriad of industries concerned with three-dimensional image display, it is expected that technical spin-offs from the three-dimensional image-displaying device will be extensive.

The three-dimensional displaying technology is divided into a depth image method, a stereoscopic image method and a three-dimensional image method according to a level of display capability. It is also divided into a still image method and a moving image method according to whether or not the display image is moved.

For example, the depth image method reproduces depth information of an object image so that a two-dimensional image has a three-dimensional appearance to the observer. The former is usually applied to three-dimensional computer graphics in which perspective projection, superimposition, shade, luminance and the like are displayed by calculation, and the latter is applied to a so-called IMAX movie in which a very large screen having a wide viewing angle is provided to an observer so that the observer believes he is viewing a three-dimensional image.

According to the present invention, there is proposed a method of supplying perspective to a three-dimensional image, in which a plurality of displaying surfaces are respectively disposed at different positions having different depths from each other, and a two-dimensional image is displayed on each displaying surface, and an object image is formed between the displaying surfaces by an intermediate image formation, and then the object image is moved.

For example, when the object image is moved in the direction of depth, the object image is moved to become farther from an observer and then moved nearer to the observer, thereby giving perspective to the three-dimensional image. The method of supplying perspective to the three-dimensional image may be applied to a displaying device for a car.

Usually, a displaying surface of the displaying device is a single screen. So far, there has not been presented a displaying device using the plurality of displaying surfaces.

In Japanese Patent No. 3022558 entitled “Three-dimensional displaying method and device”, the displaying device, which is not limited to being used only in a car, employs a plurality of displaying surfaces. Furthermore, in the displaying method, an object image is formed between panels by using corresponding units, and the formed object image is moved in a depth direction, and at this time, the object image is moved to become far off from an observer and then moved to get nearer to the observer.

In the above-mentioned method of displaying the object image using two displaying surfaces (panels), when the object image is moved from the displaying surface (hereinafter, called “front panel) near the observer to the displaying surface (hereinafter, called “rear panel) far from the observer, if a moving distance of the object image is short, it is not possible to emphasize the fact that the object image is moving, and the observer (e.g., a driver) could not recognize the movement of the object image.

Furthermore, when the object image formed by the intermediate image formation is moved from the front panel toward the rear panel, if the object image is moved to the same position as the rear panel, it seems that the object image is attached to the rear panel. Therefore, it looks strange, that is, the driver feels a sense of incongruity.

Furthermore, the object image formed at a space between the two panels has a lower imaging performance than the two-dimensional image displayed on the displaying surface.

To this end, the object image formed at a space between the two panels becomes foggy. Due to this fogginess, the driver feels a sense of incongruity.

A level of the fogginess is changed complicatedly by a distance from the front panel to the object image when the object image is moved from the front panel toward the rear panel.

In order to obtain a three-dimensional object image having an excellent cubic effect and also preventing the driver from having the sense of incongruity, it is important to reduce the sense of incongruity in the movement of the object image.

The information disclosed in this Background of the Invention section is only for enhancement of understanding of the background of the invention and should not be taken as an acknowledgement or any form of suggestion that this information forms the prior art that is already know to a person skilled in the art.

### SUMMARY OF THE INVENTION

In one aspect a displaying device using two displaying surfaces, when the object image formed by an intermediate image formation, e.g., the object image like a warning indication icon on an information screen in a cluster of a car is moved in a depth direction and the object image is moved to become far off from an observer and then moved to get nearer to the observer, a turning point that the object image is turned reversely is optimized, thereby preventing the observer from having a sense of incongruity.

Other aspects of the present invention can be achieved by providing a method of displaying an object image, in which a two-dimensional image is displayed on each of a plurality of displaying surfaces which are respectively disposed at different depths from each other so that the two-dimensional images on each displaying surface are superimposed in a direction of observer's sight with respect to the displaying surfaces. The two-dimensional image displayed on each displaying surface is changed independently for each displaying surface so that the object image is moved further away from observer and then moved closer to the observer, characterized in that, when the object image is moved in a direction which becomes far off from the observer. The luminance of the two-dimensional surface displayed on the displaying surface near to the observer is reduced in turn and the luminance of the two-dimensional surface displayed on the displaying surface far from the observer is increased in turn and changing of the luminance is performed at a turning point. When the object image is moved in a direction nearer to the observer, the luminance of the two-dimensional surface displayed on the displaying surface nearer to the observer is increased in turn and the luminance of the two-dimensional surface displayed on the displaying surface far from the observer is reduced in turn.

Preferably, the turning point is located at a position between the displaying surface farthest from the observer and a middle point of a space position between the displaying surface farthest from the observer and the displaying surface nearest from the observer.

Preferably, the turning point is located at a position between a middle position of resolution between a resolution value of the displaying surface farthest from the observer and a lowest resolution value, and a position having the lowest resolution.

Preferably, the turning point is located at an overlapped position between the position in claim 2 and the position in claim 3.

The present invention can be achieved by providing a method of displaying an object image, in which a two-dimensional image is displayed on each of a plurality of displaying surfaces which are respectively disposed at different depths from each other so that the two-dimensional images on each displaying surface are superimposed in a direction of observer's sight with respect to the displaying surfaces, thereby forming the object image, and luminance of the two-dimensional image displayed on each displaying surface is changed independently for each displaying surface so that the object image is moved in a depth direction further from the observer and then moved nearer to the observer. When the object image is moved from the displaying surface nearest to the observer toward a desired position, the luminance of the two-dimensional surface displayed on the displaying surface nearer to the observer is reduced in turn and the luminance of the two-dimensional surface displayed on the displaying surface farther from the observer is increased in turn and changing of the luminance is performed at a turning point, and when the object image is moved from a desired point of a space position toward the displaying surface farthest from the observer, a lowering level of the luminance of the two-dimensional image displayed on the displaying surface near to the observer is increased and the luminance of the two-dimensional image displayed on the displaying surface far from the observer is reduced When the object image is moved from the displaying surface farther from the observer to a desired position, the luminance of the two-dimensional surface is reduced gradually, and when the object image is moved from a desired point of the space position toward the displaying surface nearest to the observer, the increasing level of the luminance of the two-dimensional surface displayed on the displaying surface near to the observer is reduced and the luminance of the two-dimensional surface displayed on the displaying surface far from the observer is reduced gradually.

The present invention can be achieved by providing a method of displaying an object image, in which a two-dimensional image is displayed on each of a plurality of displaying surfaces which are respectively disposed at different depths from each other so that the two-dimensional images on each displaying surface are superimposed in a direction of observer's sight with respect to the displaying surfaces, thereby forming the object image, and luminance of the two-dimensional image displayed on each displaying surface is changed independently for each displaying surface so that the object image is moved in a depth direction farther from the observer and then moved to get nearer to the observer. In the case that the object image is moved in a direction which becomes farther off from the observer, when the object image is moved from the displaying surface nearest to the observer toward a desired position, the luminance of the two-dimensional surface displayed on the displaying surface nearer to the observer is reduced in turn and the luminance of the two-dimensional surface displayed on the displaying surface farther from the observer is increased in turn. When the object image is moved from a desired point of a space position toward the displaying surface farthest from the observer, a lowering level of the luminance of the two-dimensional image displayed on the displaying surface nearer to the observer is increased and the luminance of the two-dimensional image displayed on the displaying surface farther from the observer is not changed. When the object image is moved from the displaying surface farther from the observer to a desired position, the luminance of the two-dimensional surface displayed on the displaying surface nearer to the observer is increased and the luminance of the two-dimensional surface displayed on the displaying surface farther from the observer is not changed. When the object image is moved from a desired point of the space position toward the displaying surface nearest to the observer, the increasing level of the luminance of the two-dimensional surface displayed on the displaying surface nearer to the observer is reduced and the luminance of the two-dimensional surface displayed on the displaying surface farther from the observer is reduced.

The present invention can be achieved by providing a method of displaying an object image, in which a two-dimensional image is displayed on each of a plurality of displaying surfaces which are respectively disposed at different depths from each other. The two-dimensional images on each displaying surface are superimposed in a direction of observer's sight with respect to the displaying surfaces, thereby forming the object image, and luminance of the two-dimensional image displayed on each displaying surface is changed independently for each displaying surface. The object image is moved in a depth direction so as to become farther from the observer and then moved nearer to the observer and the object image is moved in a direction which becomes farther off from the observer, when the object image is moved from the displaying surface nearer to the observer toward a desired position, the luminance of the two-dimensional surface displayed on the displaying surface near to the observer is reduced in turn. The luminance of the two-dimensional surface displayed on the displaying surface farther from the observer is increased in turn, and when the object image is moved from a desired point of a space position toward the displaying surface farthest from the observer, a lowering level of the luminance of the two-dimensional image displayed on the displaying surface near to the observer is increased. An increasing level of the luminance of the two-dimensional image displayed on the displaying surface farther from the observer is reduced. When the object image is moved from the displaying surface far from the observer to a desired position, the luminance of the two-dimensional surface displayed on the displaying surface nearer to the observer is increased and the luminance of the two-dimensional surface displayed on the displaying surface farther from the observer is reduced, and when the object image is moved from a desired point of the space position toward the displaying surface nearest to the observer, the increasing level of the luminance of the two-dimensional surface displayed on the displaying surface near to the observer is reduced and the luminance of the two-dimensional surface displayed on the displaying surface far from the observer is increased.

Preferably, the desired point of the space position is set to a position having a lowest luminance in a space between the displaying surface nearest to the observer and the displaying surface farthest from the observer.

The present invention can be achieved by providing a method of displaying an object image, in which a two-dimensional image is displayed on each of a plurality of displaying surfaces (a front panel and a rear panel) which are respectively disposed at different depths from each other so that the two-dimensional images on each displaying surface are superimposed in a direction of observer's sight with respect to the displaying surfaces, thereby forming the object image, and luminance of the two-dimensional image displayed on each displaying surface is changed independently for each displaying surface so that the object image is moved in a depth direction farther from the observer and then moved nearer to the observer, characterized in that:

When the luminance displayed on the front panel and the rear panel is changed, a lowering level of the luminance of entire panel is changed with a luminance recovery point as a starting point so as to prevent an action of luminance recovery portion, and with the luminance recovery point as the starting point, a reducing level of the luminance of the front panel is increased and an increasing level of the luminance of the rear panel is reduced, and if the image is located at the rear panel, the luminance of the front panel is set to 0% and at the same time, the luminance of the rear panel is controlled optionally, and if the image is located at the front panel, the luminance of the rear panel is set to 0% and at the same time, the luminance of the rear panel is controlled optionally.

In another aspect, motor vehicles are provided that comprise a display device using a described method.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present methods will be particularly useful with a wide variety of motor vehicles.

Other aspects of the invention are discussed infra.

### BRIEF DESCRIPTION OF THE DRAWINGS

The above and/or other aspects and advantages of the prevent invention will become apparent and more readily appreciated from the following description of the exemplary embodiments, taken in conjunction with the accompanying drawings, in which:

FIG. 1 is a view showing an embodiment of the present invention;

FIG. 2 is a graph showing the relationship between the resolution and space position in the method of displaying an object image according to the present invention;

FIG. 3 is a graph showing the relationship between the luminance and space position in the method of displaying the object image according to the present invention;

FIG. 4 is a graph showing a linearly moving object in the method of displaying the object image according to the present invention;

FIG. 5 is a graph showing the status of a continuously moving object in the method of displaying the object image according to the present invention;

FIG. 6 is a graph showing an object that moves in one direction, stops, and reverses direction in the method of displaying the object image according to the present invention;

FIG. 7 is a graph showing another type of object movement in the method of displaying the object image according to the present invention;

FIGS. 8a to 8c are graphs showing a method of regulating the luminance of the front panel and the rear panel;

FIG. 9 is a graph showing the luminance of the object image between the front panel and the rear panel;

FIGS. 10a to 10c are graphs showing the method of regulating the luminance of the front panel and the rear panel according to the present invention; and

FIG. 11 is a graph showing the luminance of the object image between the front panel and the rear panel.

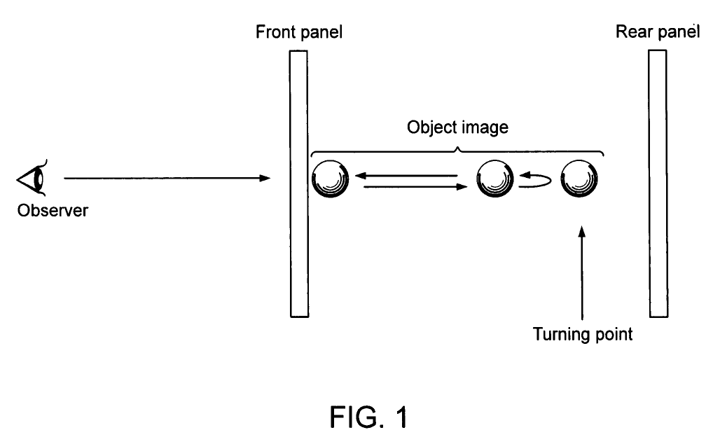

### DETAILED DESCRIPTION

Reference will now be made in detail to the preferred embodiment of the present invention, examples of which are illustrated in the accompanying drawings.

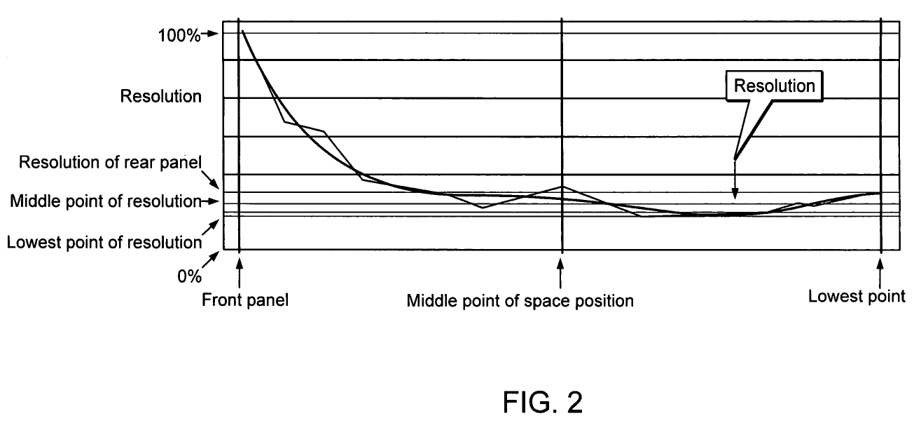

FIG. 2 is a graph showing the relationship between the resolution and space position in the method of displaying an object image according to the present invention.

The graph of FIG. 2 is obtained by measuring a level of fogginess of the object image formed between a front panel and a rear panel. As shown in the graph, the luminance of the front panel is linearly changed from 100% to 0%, and at the same time, the luminance of the rear panel is linearly changed from 0% to 100%. The resolution in the graph of FIG. 2 is the ratio of the luminance to one pixel (luminance/pixel). Assuming the resolution of the front panel is 100%, a numerical change of the resolution is indicated in the graph of FIG. 2. The middle point of the resolution is the middle point between the resolution of the rear panel and the lowest point of the resolution. Furthermore, the middle point of the space position is the middle point between the front panel and the rear panel.

According to the graph of FIG. 2, the front panel has the highest resolution, and the resolution is lowered toward the rear panel.

After that, the resolution has the lowest point at a middle position between the middle point of the space position and the rear panel, and then the resolution is gradually increased from the lowest point toward the rear panel.

Referring to the graph of FIG. 2, some embodiments for the method of moving the object image according to the present invention, in which the driver does not feel a sense of incongruity, will be described.

In one embodiment, when the object image is moved from the front panel toward the rear panel, a resolution of the object image is gradually lowered (i.e., the object image becomes foggy), and then gradually increased after reaching the lowest point.

In case that the object image is moved from the front panel toward the rear panel and then back toward the front panel with a certain point as the limit, preferably, when the object image is moved from the front panel toward the rear panel, the object image gradually becomes foggy, and when the object image is turned back from the rear panel toward the front panel with the certain point as the limit, the object image becomes clear again.

Therefore, in case that the luminance of the front panel and the rear panel is linearly changed, it is preferred that a turning point of the object image is set at a position between the lowest point of the resolution and the neighborhood of the front panel.

If the turning point of the object image is set at a position between the lowest point of the resolution and the neighborhood of the rear panel, when the object image is moved from the front panel toward the rear panel, the object image is returned at a point of time when the object image becomes clear gradually after being foggy. Therefore, the driver (i.e., an observer who watches the panel) feels the sense of incongruity.

However, although the turning point of the object image is set at a position between the lowest point of the resolution and the neighborhood of the rear panel, if a recovery of the resolution is very slight, the driver does not recognize the recovery.

A critical point that the driver does not recognize the recovery is located at a middle point of Y axis (resolution) of FIG. 2.

Therefore, in the embodiment of the present invention, the turning point is set at a position between the middle point of the resolution and the lowest point of the resolution.

### Second Embodiment

When the object image formed by the intermediate image formation is moved from the front panel toward the rear panel, if the object image is moved to the same position as the rear panel, since it seems that the object image is attached to the rear panel, the driver feels a sense of incongruity. Therefore, in the embodiment, the object image is not moved as far as the rear panel.

### Third Embodiment

If a moving distance from the front panel toward the rear panel is short, since it is not possible to emphasize a fact that the object image is moving and the observer (e.g., a driver) could not recognize the movement of the object image, the turning point is set at a position between the middle point of X axis (space position) and the rear panel.

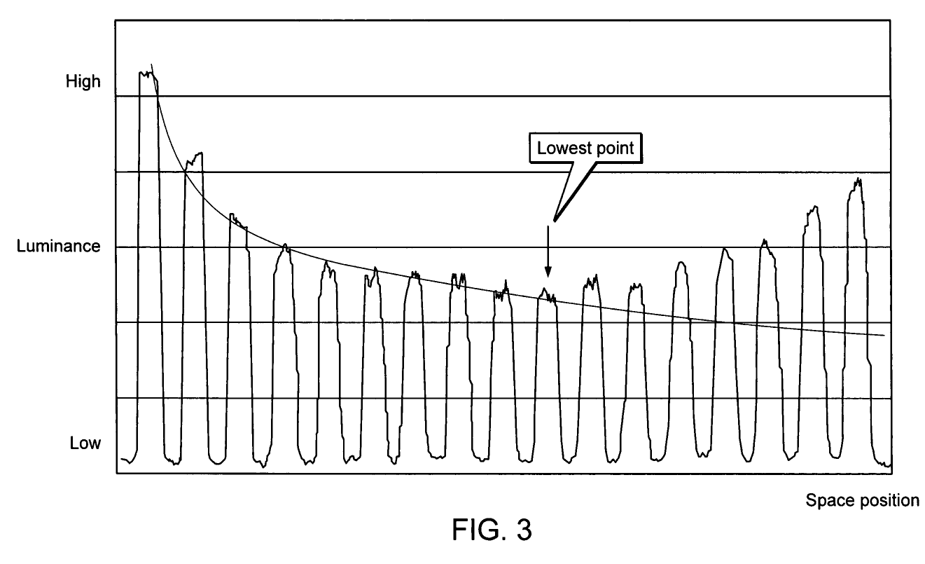

Furthermore, the graph of FIG. 3 is obtained by measuring the luminance between the front panel and the rear panel. In FIG. 3, a red line is a measured value, and a blue line is a value of the present invention. According to FIG. 3, the more it is near to the front panel and the rear panel, the higher the luminance becomes. And the luminance is low at the middle point of the space position between the front panel and the rear panel.

Referring to FIGS. 2 and 3, the method of displaying the object image, i.e., the method of moving the object image according to the present invention will be described in detail.

In the method of moving the object image according to the present invention, the object image is moved from the front panel toward the rear panel and then and a certain point, turned back from the rear panel toward the front panel. In the above method, the longer the distance moved from the front panel toward the rear panel, the more the movement of the object image can be emphasized. In other words, since the object image includes a certain message, the more the movement of the object image is emphasized, the more the message included therein is emphasized. Therefore, the longer the object image is moved, the better.

However, in the case that the object image is moved as aforementioned, it is preferred that the turning point is set so that the luminance of the object image is the highest at the front panel and gradually becomes lower toward the rear panel and then gradually higher again toward the rear panel with a point as the border.

If the turning point is set at a position between the lowest point of the luminance and the neighborhood of the rear panel, when the object image is moved from the front panel toward the rear panel, since the luminance of the object image becomes low gradually and then the object image is returned at a point of time when the luminance becomes high, it seems that the object image is attached to the rear panel and thus the driver (i.e., an observer who watches the panel) feels the sense of incongruity. Therefore, if the object image is located at a position which is closer to the rear panel than the space position having the lowest point of the luminance, the luminance of each of the front panel and the rear panel is changed as portrayed by the blue line of FIG. 3, i.e., to gradually become low.

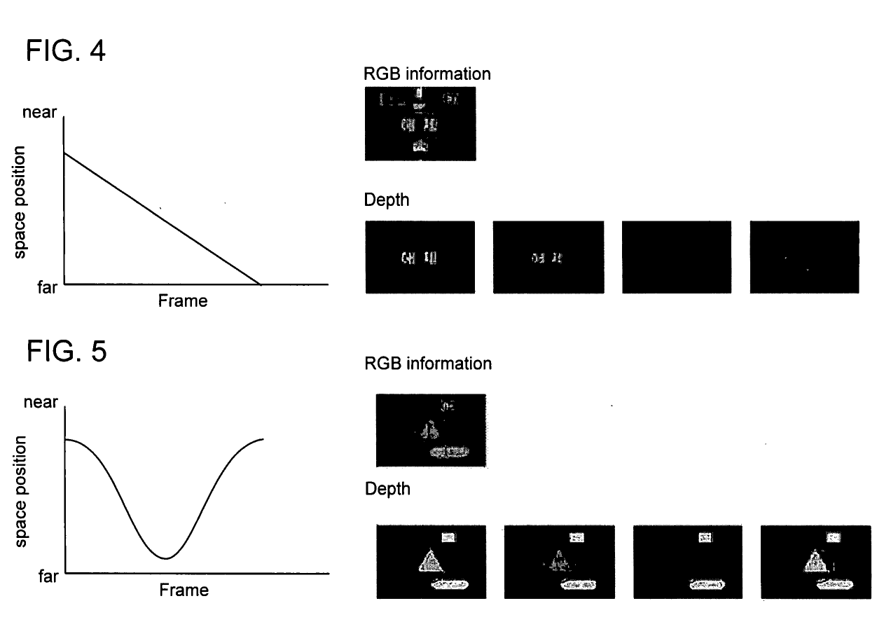

By the change of the luminance, the lowest point of the luminance is located at a position closer to the rear panel. Thus, the moving distance from the front panel toward the rear panel can be extended without the sense of incongruity. There are other methods of moving the object image as shown in FIGS. 4 to 7. In these methods, it is ascertained that a moving speed has preferably the number of frames as related in the figures. It is hard to optimize a numerical value because of the nature of the present invention. If the method of optimizing the numerical value is well-known in the art, there is no restriction on employing the method.

Furthermore, the moving speed in FIGS. 4 to 7 is the number of frames at 30 frames-per-second (fps).

FIG. 4 shows a linearly moving status, wherein the moving speed is approximately 5-10 fps and a moving method is either 100%-0% or 0%-100%.

Herein, F indicates the front panel (100%) and R is the rear panel (0%).

FIG. 5 shows a repeated moving status, wherein the moving speed is 10-15 fps and a moving method is 100%-20%-100%.

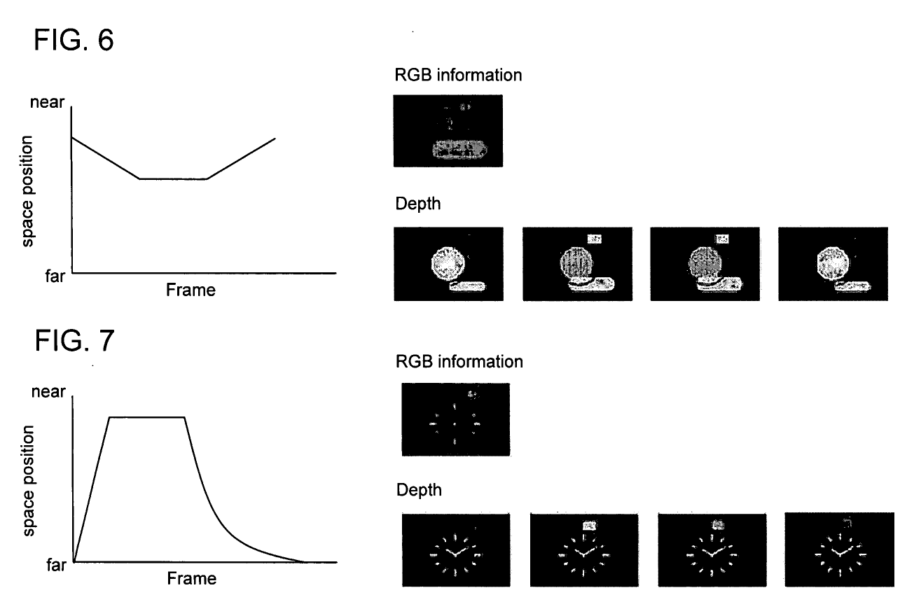

FIG. 6 shows a stop-and-moving status, wherein the moving speed is 5-10 fps at a changing portion thereof and a moving method is 100%-60% (optional)-100%.

FIG. 7 shows another moving status, wherein the moving speed is 5-10 fps at a changing portion thereof and a moving method is 0%-100%-0%.

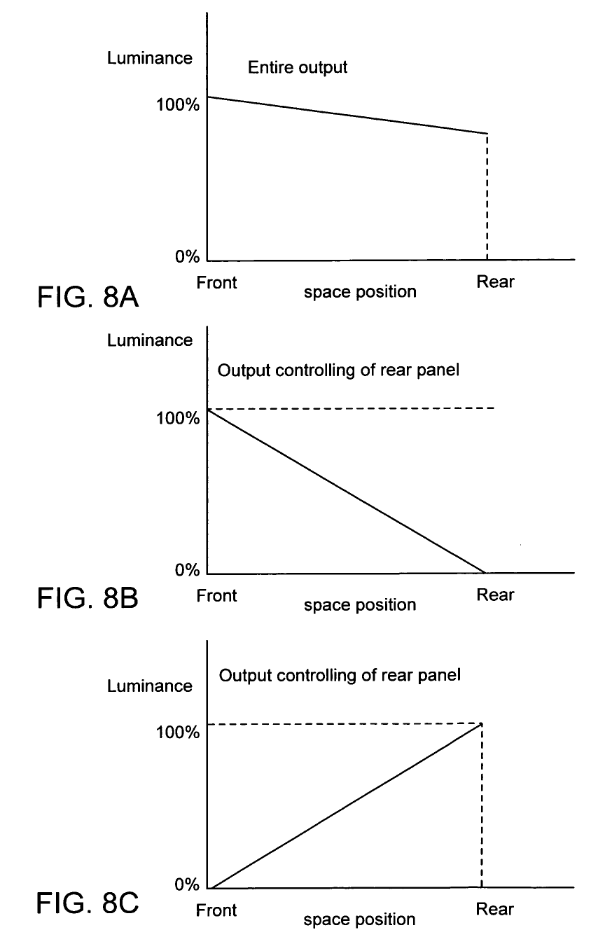

In another embodiment of the method of regulating the luminance of the front panel (displaying surface) and the rear panel (displaying surface) will be described. In case of a usual existing method (e.g.: NTT), when the image is moved from the front panel toward the rear panel, the luminance of entire panels (including the front panel and the rear panel) becomes low (FIGS. 8a to 8c). This is caused by lowering of the luminance of the rear panel due to transmittance when the luminance of the rear panel is passed through the front panel, since the front panel is interposed between the rear panel and the driver. Furthermore, the transmittance is changed, depending on the type of panel or a distance between the front panel and the rear panel.

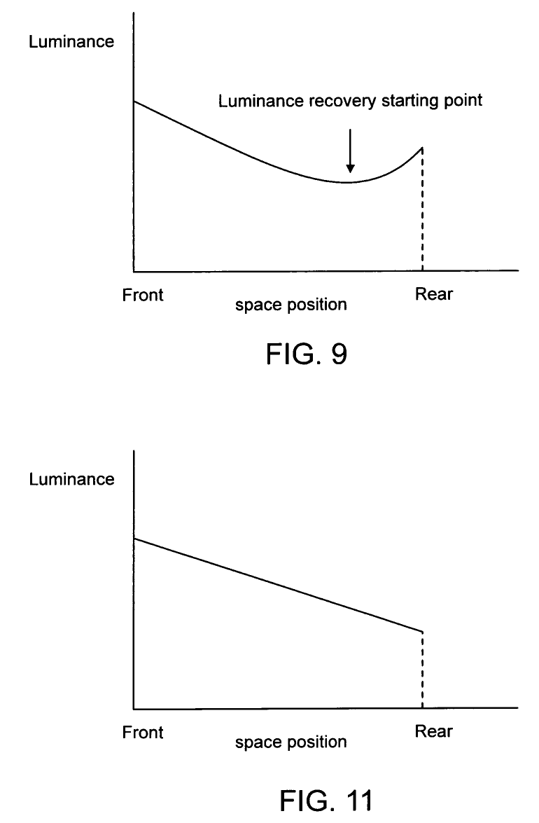

In the case that the luminance of each panel is regulated as described above, the luminance of the image is recovered at one point as shown in FIG. 9. Therefore, when the image is moved from the front panel toward the rear panel, it appears that the image is attached to the rear panel by the action of the recovery point of luminance.

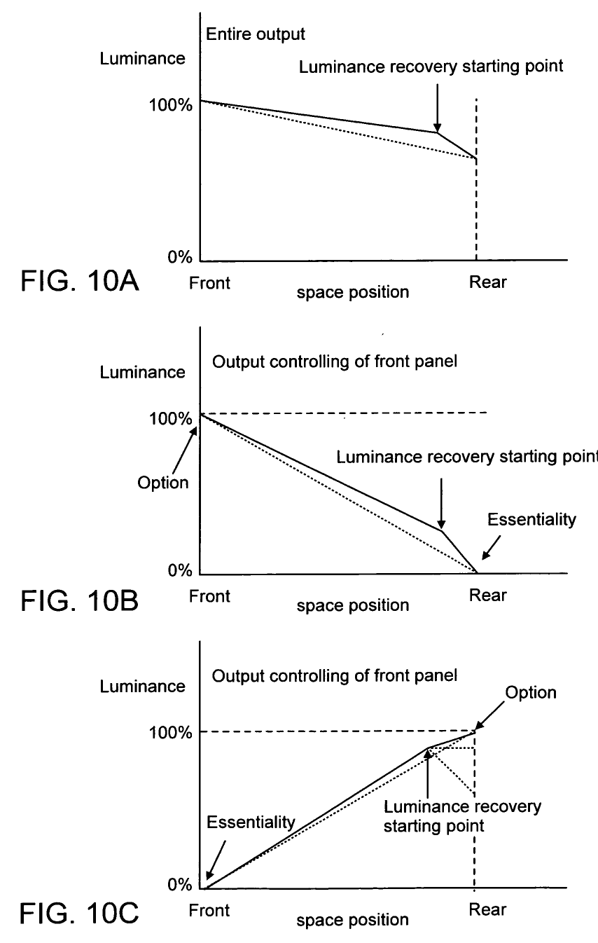

According to the present invention, in order to prevent the action of the recovery point of luminance, as shown in FIG. 10a, a lowering level of the luminance of the entire panels is changed with the recovery point of luminance of FIG. 9 as a starting point.

Moreover, the lowering level of the luminance of the front panel is increased with the luminance recovery point as the starting point (FIG. 10b), and the increasing level of the luminance of the rear panel is reduced (FIG. 10c). In output controlling of the front panel (FIG. 10b), when the image is located at the rear panel, the luminance of the front panel should be 0% (FIG. 10b arrow of “essentiality”). This is because the image is located between the front panel and the rear panel, not at the rear panel, regardless of the percent of the luminance of the rear panel, if the luminance of the front panel is 10%.

Furthermore, if the image is located at the front panel, it does not matter that the luminance of the front panel is not 100% (FIG. 10b arrow of “option”). Although the luminance of the front panel is 70%, not 100%, if the luminance of the rear panel is 0%, the image is located at the front panel. Only a brightness of the image becomes slightly darker in comparison with a brightness of 100%.

This is also similar to the controlling of the rear panel (FIG. 10c). When the image is located at the front panel, the luminance of the rear panel should be 0% (FIG. 10c arrow of “essentiality”). Furthermore, if the image is located at the rear panel, it does not matter that the luminance of the rear panel is not 100% (FIG. 10c arrow of “option”). Therefore, if the image is moved from the luminance recovery starting point toward the rear panel, it is possible to change the luminance as shown by the blue line in FIG. 10c (there is no restriction on the rate of change if it is less than that of the red line in FIG. 10c).

The control of the luminance of each panel as described above, is shown in FIG. 11. Thus, it is possible to eliminate the sense of incongruity due to the appearance that the image is attached to the rear panel.

As aforementioned, in a displaying device using a plurality of displaying surfaces, when the object image formed by an intermediate image formation is moved in a depth direction and the object image is moved to become farther from an observer and then moved nearer to the observer, a method according to the present invention is used, thereby preventing the observer from having a sense of incongruity.

Although a few exemplary embodiments of the present invention have been described, it will be appreciated by those skilled in the art that changes may be made in these embodiments without departing from the principles and spirit of the invention.

1. A method of displaying an object image, in which a two-dimensional image is displayed on each of a plurality of displaying surfaces which are respectively disposed at different depths from each other so that the two-dimensional images on each displaying surface are superimposed, thereby forming the object image, and the luminance of the two-dimensional image displayed on each displaying surface is changed independently for each displaying surface so that when the object image is moved
the luminance of the two-dimensional image displayed on a displaying surface nearer to the observer is reduced as the object is moved further in depth and the luminance of the two-dimensional image displayed on a displaying surface farther from the observer is increased, wherein the change in luminance between display surfaces occurs at a turning point, and as the object moves nearer to the observer, the luminance of the two-dimensional image displayed on the displaying surface nearer to the observer is increased and the luminance of the two-dimensional image displayed on the displaying surface farther from the observer is reduced.

2. The method according to claim 1, wherein the turning point is located at a position between the displaying surface farthest from the observer and a middle point in space between the displaying surface farthest from the observer and the displaying surface nearest from the observer.

3. The method according to claim 1, wherein the turning point is located at the midpoint of the resolution value of the displaying surface farthest from the observer and the lowest resolution value.

4. The method according to claim 1, wherein the turning point is located at an overlapping point between the position in claim 2 and the position in claim 3.

5. A method of displaying an object image, in which a two-dimensional image is displayed on each of a plurality of displaying surfaces which are respectively disposed at different depths from each other so that the two-dimensional images on each displaying surface are superimposed, thereby forming the object image, and luminance of the two-dimensional image displayed on each displaying surface is changed independently for each displaying surface so that when the object image is moved:
as the object image is moved further from the observer, the luminance of the two-dimensional image displayed on the displaying surface nearer to the observer is reduced and the luminance of the two-dimensional image displayed on the displaying surface farther from the observer is increased, wherein changing of the luminance is performed at a turning point, and when the object image is moved from a desired point of a space position toward the displaying surface farthest from the observer, a lowering level of the luminance of the two-dimensional image displayed on the displaying surface near to the observer is increased and the luminance of the two-dimensional image displayed on the displaying surface far from the observer is reduced, and in case that the object image is moved in a direction nearer to the observer, when the object image is moved from the displaying surface farther from the observer to a desired position, a increasing level of the luminance of the two-dimensional image displayed on the displaying surface near to the observer is increased and the luminance of the two-dimensional image displayed on the displaying surface far from the observer is gradually reduced, and when the object image is moved from a desired point in space toward the displaying surface nearest to the observer, the increasing level of the luminance of the two-dimensional image displayed on the displaying surface near to the observer is reduced and the luminance of the two-dimensional image displayed on the displaying surface far from the observer is gradually reduced.

6. A method of displaying an object image, in which a two-dimensional image is displayed on each of a plurality of displaying surfaces which are respectively disposed at different depths from each other so that the two-dimensional images on each displaying surface are superimposed, thereby forming the object image, and luminance of the two-dimensional image displayed on each displaying surface is changed independently for each displaying surface so that the object image is moved in a depth direction so as to become far off from the observer and then moved to get nearer to the observer, characterized in that:
in case that the object image is moved in a direction which becomes far off from the observer, when the object image is moved from the displaying surface nearest to the observer toward a desired position, the luminance of the two-dimensional image displayed on the displaying surface near to the observer is reduced in turn and the luminance of the two-dimensional image displayed on the displaying surface far from the observer is increased in turn, and when the object image is moved from a desired point of a space position toward the displaying surface farthest from the observer, a lowering level of the luminance of the two-dimensional image displayed on the displaying surface near to the observer is increased and the luminance of the two-dimensional image displayed on the displaying surface far from the observer is not changed, and in case that the object image is moved in a direction which gets nearer to the observer, when the object image is moved from the displaying surface far from the observer to a desired position, the luminance of the two-dimensional image displayed on the displaying surface near to the observer is increased and the luminance of the two-dimensional image displayed on the displaying surface far from the observer is not changed, and when the object image is moved from a desired point of the space position toward the displaying surface nearest to the observer, the increasing level of the luminance of the two-dimensional image displayed on the displaying surface near to the observer is reduced and the luminance of the two-dimensional image displayed on the displaying surface far from the observer is reduced.

7. A method of displaying an object image, in which a two-dimensional image is displayed on each of a plurality of displaying surfaces which are respectively disposed at different depths from each other so that the two-dimensional images on each displaying surface are superimposed in a direction of observer's sight with respect to the displaying surfaces, thereby forming the object image, and luminance of the two-dimensional image displayed on each displaying surface is changed independently for each displaying surface so that the object image is moved in a depth direction so as to become far off from the observer and then moved to get nearer to the observer, characterized in that:
in case that the object image is moved in a direction which becomes far off from the observer, when the object image is moved from the displaying surface near to the observer toward a desired position, the luminance of the two-dimensional image displayed on the displaying surface near to the observer is reduced in turn and the luminance of the two-dimensional image displayed on the displaying surface far from the observer is increased in turn, and when the object image is moved from a desired point of a space position toward the displaying surface farthest from the observer, a lowering level of the luminance of the two-dimensional image displayed on the displaying surface near to the observer is increased and an increasing level of the luminance of the two-dimensional image displayed on the displaying surface far from the observer is reduced, and in case that the object image is moved in a direction which gets nearer to the observer, when the object image is moved from the displaying surface far from the observer to a desired position, the luminance of the two-dimensional surface displayed on the displaying surface near to the observer is increased and the luminance of the two-dimensional image displayed on the displaying surface far from the observer is reduced, and when the object image is moved from a desired point of the space position toward the displaying surface nearest to the observer, the increasing level of the luminance of the two-dimensional image displayed on the displaying surface near to the observer is reduced and the luminance of the two-dimensional image displayed on the displaying surface far from the observer is increased.

8. The method according to any one of claims 5 to 7, wherein the desired point of the space position is set to a position having a lowest luminance in a space between the displaying surface nearest to the observer and the displaying surface farthest from the observer.

9. A method of displaying an object image, in which a two-dimensional image is displayed on each of a plurality of displaying surfaces which are respectively disposed at different depths from each other so that the two-dimensional images on each displaying surface superimposed in a direction of observer's sight with respect to the displaying surfaces, thereby forming the object image, and luminance of the two-dimensional image displayed on each displaying surface is changed independently for each displaying surface so that the object image is moved in a depth direction so as to become far off from the observer and then moved to get nearer to the observer, characterized in that:
when the luminance displayed on the front panel and the rear panel is changed, a lowering level of the luminance of all panels is changed with a luminance recovery point as a starting point so as to prevent an action of luminance recovery portion, and with the luminance recovery point as the starting point, a reducing level of the luminance of the front panel is increased and an increasing level of the luminance of the rear panel is reduced, and if the image is located at the rear panel, the luminance of the front panel is set to 0% and at the same time, the luminance of the rear panel is set optionally, and if the image is located at the front panel, the luminance of the rear panel is set to 0% and at the same time, the luminance of the rear panel is set optionally.

10. A method of displaying an object on a plurality of display surfaces arranged in increasing depth from an observer comprising the steps of:
(a) setting a luminance value of the object on each of the plurality of display surfaces such that, as the object is moved farther in depth from the observer, the luminance value is increased on display surfaces farther from the observer and decreased on display surfaces nearer to the observer, and;
(b) setting the luminance value of the object on each of the plurality of display surfaces such that, as the object is moved nearer in depth to the observer, the luminance value is increased on display surfaces nearer to the observer and decreased on display surfaces farther from the observer.

11. A motor vehicle comprising a display device using the method of claim 1.
